(19) United States
(12) Patent Application Publication
(10) Pub. No.: US 2016/0136038 A1
(43) Pub. Date: May 19, 2016

(54) MASSAGE DEVICE

(71) Applicant: DANZHI CAI, Shenzhen (CN)

(72) Inventor: DANZHI CAI, Shenzhen (CN)

(21) Appl. No.: 14/547,596

(22) Filed: Nov. 19, 2014

(51) Int. Cl. A61H 19/00; A61H 23/00

(52) U.S. Cl. CPC A61H 19/34; A61H 23/00

(57) ABSTRACT

A massage device includes a main body, and a flexible outer layer completely sealing the main body. The flexible outer layer can prevent dust or water from corrupting a plurality of electronic components received in the receiving chamber of the massage device.

### CROSS-REFERENCE TO RELATED APPLICATIONS

This application is related to three co-pending U.S. patent applications (Attorney Docket Nos. US57517, US57518, US57638), entitled “MASSAGE DEVICE”, “PRESSING CONTACT MODULE AND MASSAGE DEVICE USING THE SAME”, “MASSAGE DEVICE”, respectively, by Danzhi Cai. The applications have the same assignee as the instant application and are concurrently filed on the same day. The disclosure of the above-identified applications is incorporated herein by reference.

### FIELD

The subject matter herein generally relates to devices, especially to a massage device for promoting female sexual wellness and function.

### BACKGROUND

A variety of handheld sexual stimulating devices have been described in the art, many of which are commercially available. The massage devices of the prior art may use a plurality of interchangeable massage heads having different surface textures or configurations. The massage device may further include a mechanical vibration module and an interface, such as a communications and charging interface, with a plurality of contacts.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is an isometric view of an embodiment of a massage device including a main body and a base, the main body having a flexible outer layer.

FIG. 2 is an exploded view of the massage device shown in FIG. 1.

FIG. 3 is an isometric view of the main body of the massage device shown in FIG. 1 without the flexible outer layer.

FIG. 4 is a cross-sectional view of the massage device shown in FIG. 1, taken along line IV-IV.

FIG. 5 is a block diagram of the main body of the massage device shown in FIG. 1 with an external intelligent terminal.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

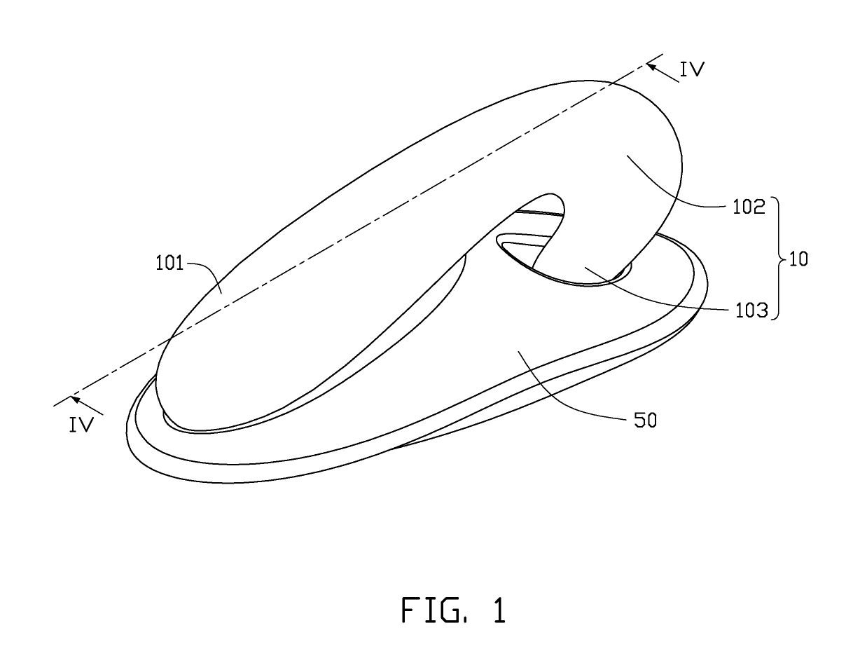

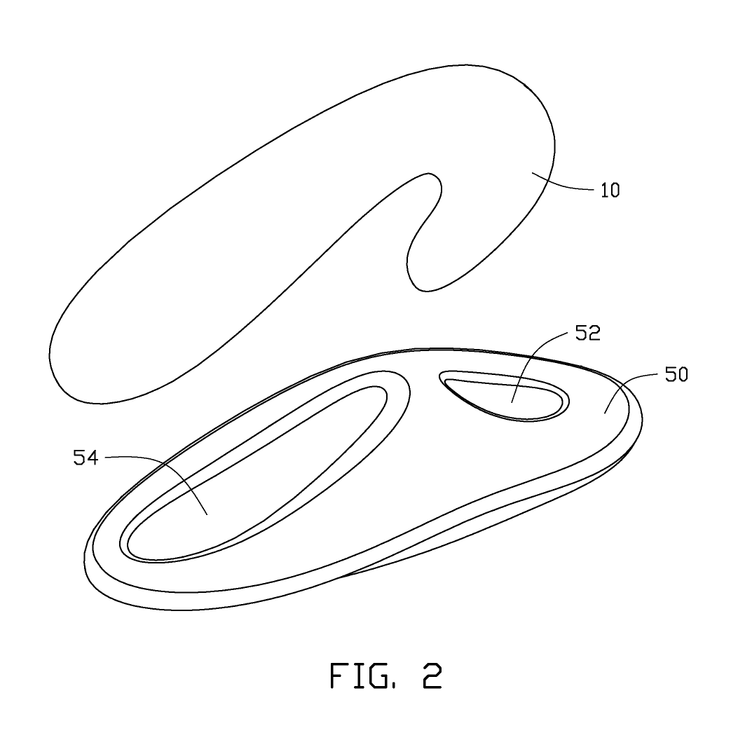

FIGS. 1 through 3 show an exemplary massage device 100. The massage device 100 can include a base 50 and a main body 10 having a chamber 104 therein. The main body 10 can stand on the base 50. The massage device 100 can further include a flexible outer layer 12 completely sealing the main body 10 for preventing dust or water from corrupting a plurality of electronic components received in the receiving chamber of the massage device 100. The flexible outer layer 12 can be composed of soft resin such as gel-like resin and the like. In other embodiments, the main body 10 can also rest on the base 50.

In one embodiment, the massage device 100 may be a vibration device used in connection with pleasure, massage, or therapeutic vibration purposes for a person or other living entity. In one embodiment, the disclosure herein of a massage device as an exemplary system and method for controlling a vibratory element may be used as a handheld, body-held and/or hand-operated or body-operated control system or method for another device.

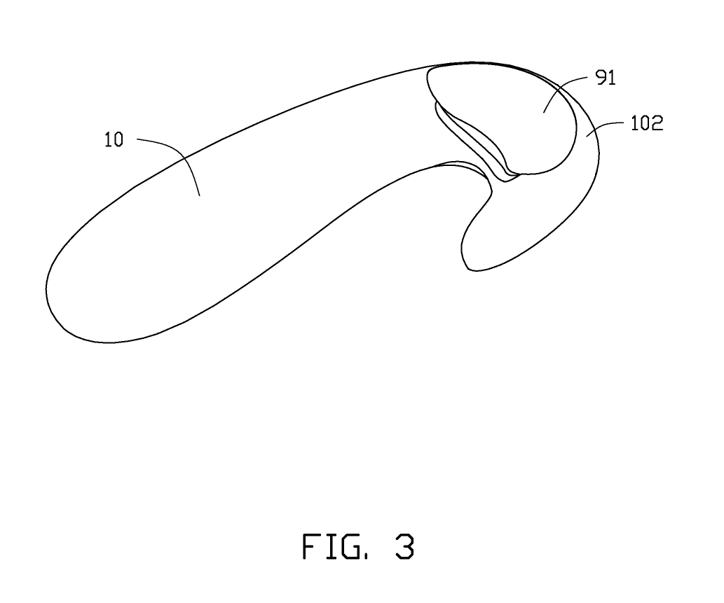

As shown in FIGS. 1 and 3, the main body 10 can be composed of at least two housings (not labeled) fixed to each other. The main body 10 can include a first end body portion 101, a second end body portion 103 substantially opposite the first end body portion 101, and an operation portion 102 connecting the second end body portion 103 and the first end body portion 101. The receiving chamber 104 extending along the second end body portion 103, the first end body portion 101, and the operation portion 102. In the embodiment, the first end body portion 101 can be a vaginal finger portion, and the second end body portion 103 can be a clitoral finger portion.

The base 50 can include a first holding portion 52 for receiving the second end body portion 103, and a second holding portion 54 for receiving the first end body portion 101, thereby the main body 10 can stand on the base 50, and the operation portion 102 of the main body 10 is located above the base 10.

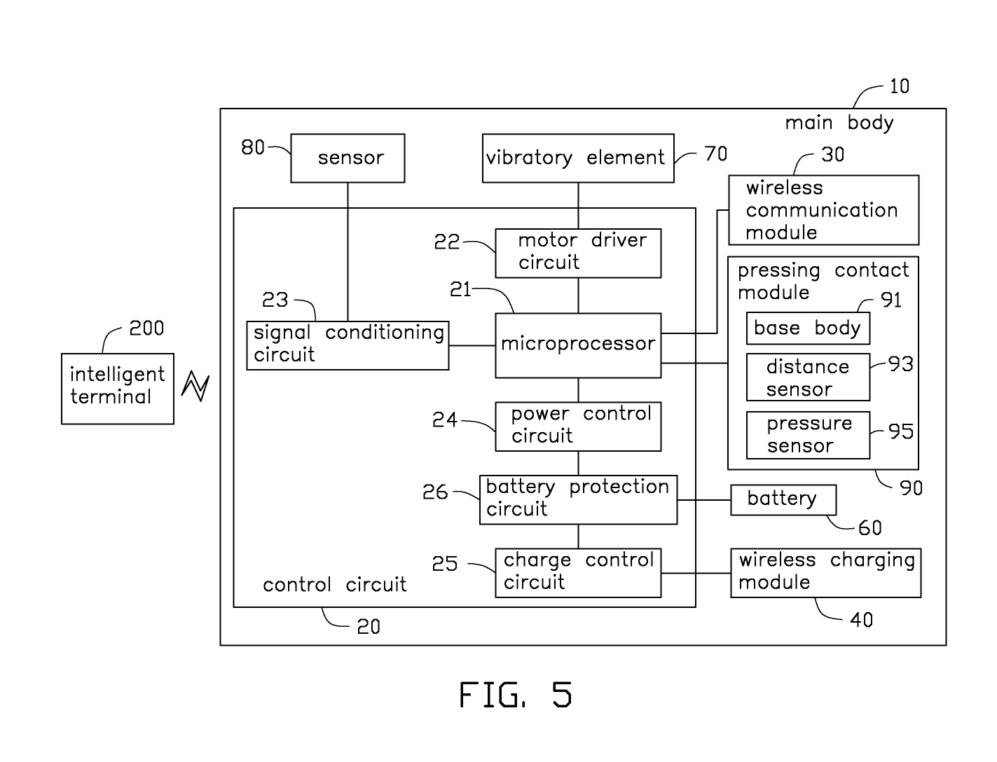

Referring to FIG. 5, the massage device can further includes a control circuit 20, a wireless communication module 30, a wireless charging module 40, a battery 60, at least two vibratory elements 70, a sensor 80 and a pressing contact module 90. The control circuit 20, the wireless communication module 30, the wireless charging module 40, the battery 60, the at least two vibratory elements 70, and the sensor 80 are received in the receiving chamber 104 of the main body 10. The wireless communication module 30, the wireless charging module 40, the battery 60, the at least two vibratory elements 70, and the sensor 80 electrically coupled to the control circuit 20 respectively. In the illustrated embodiment, the at least two vibratory elements 70 can be positioned in the receiving chamber 104 adjacent to the second end body portion 103 and the first end body portion 101 respectively. In other embodiments, one of the two or more vibratory units 70 is positioned within the first end body portion 101 and another of the two or more vibratory units 70 is positioned within the second end body portion. The vibratory elements 70, such as motors, can be controlled to affect the actuation or vibration of one or more portions of the massage device 100. The vibratory element 70 can be configured to provide contrasting, overlapping, and/or cumulative vibratory behavior in the massage device 100 that affects the entire body of the massage device 100. The sensor 80 can be positioned in the receiving chamber 104 adjacent to the first end body portion 101 for detecting a moving rate of the main body 10.

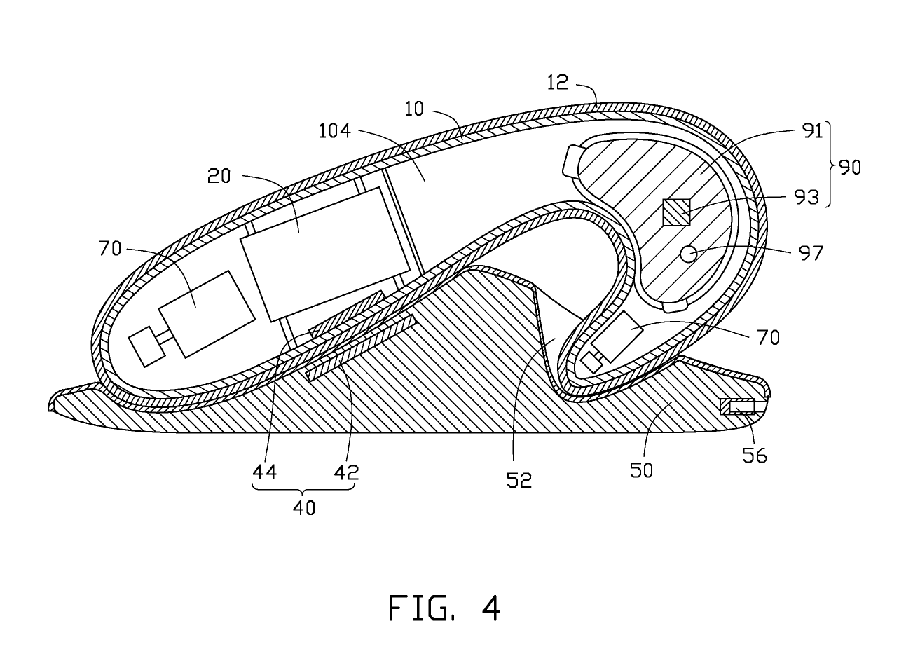

As shown in FIG. 4, the wireless charging module 40 can include a transmitting terminal 42 and a receiving terminal 44. The transmitting terminal 42 can be positioned in the base 50 between the first holding portion 52 and the second holding portion 54. The receiving terminal 44 can be positioned in the receiving chamber 104 of the main body 10. The base 50 can further include an interface 56, such as USB, in connection with the transmitting terminal 42 and an external power source for providing electronic power to the transmitting terminal 42.

Referring to FIGS. 4 and 5 again, the pressing contact module 90 can include a pressing contact module base body 91, and at least one distance sensor 93. The pressing contact module 90 is configured for controlling a vibration intensity of the at least two vibratory elements 70. The pressing contact module base body 91 is made of elastic shape memory materials, such as EVA (Ethylene-Vinyl Acetate Copolymer) foam, or Polyurethane, or the like. The pressing contact module base body 91 can be fixed in the operation portion 102, and be partially exposed of the operation portion 102 of the main body. The at least one distance sensor 93 is embedded in the pressing contact module base body 91 for detecting a deformation of the pressing contact module base body 91 and controlling or adjusting a vibration intensity of the at least two vibratory elements 70. Vibration modes can be changed depending on a deformation distance when the pressing contact module base body 91 is compressed. In other words, the pressing contact module 90 electrically coupled to the control circuit 20 for allowing an operator control the vibration modes of the at least two vibratory elements 70 via the pressing contact module 90.

As shown in FIG. 4, the pressing contact module 90 can further include a light source 97, such as LED, electrically coupled to the control circuit 20, and positioned in the pressing contact module base body 91 for illuminating the pressing contact module base body 91. The pressing contact module 90 can further include a pressure sensor 95 configured to detect a pressure level of the pressing contact module base body 91 of the pressing contact module 90 and transmit a pressure signal from the pressure sensor to the control circuit 20. The pressure sensor 95 is adapted to measure a pressure level within the pressing contact module base body 91, such as an average pressure in the pressing contact module base body 91. The control circuit 20 can transmit the pressure signals to an intelligent terminal 200 or internet via the wireless communication module 30. On the contrary, the pressing contact module 90 can be controlled by the terminal handheld terminal via the wireless communication module 30. In other words, the operator can control the intelligent terminal 200 to dominate the vibration modes of the at least two vibratory elements via the pressing contact module and the wireless communication module 30.

FIG. 5 shows a block diagram of the main body 10 of the massage device 100. The control circuit 20 can include a microprocessor 21, a motor driver circuit 22, a signal conditioning circuit 23, a power control circuit 24, a charge control circuit 25, and a battery protection circuit 26. The microprocessor 21 may be substituted in some embodiments with a microcontroller, ASIC, FPGA, SoC, or other processor or electronic device capable of processing instructions and/or signals. In the embodiment, the microprocessor 21 receives input from the pressing contact module 90 and the sensor 80, maintains mode status information (e.g., state machine information) and controls the system outputs, including directions to motor driver circuit 22 for controlling the vibratory element 70. In the illustrated embodiment, the microprocessor 21 may communicate with a computer, an intelligent terminal 200, or other electronic devices via the wireless communication module 30.

The motor driver circuit 22 can be in connection with the microprocessor 21. The motor driver circuit 22 converts signals from the microprocessor 21 into signals sufficient to operate the vibratory element 70 according to commands from the microprocessor 21. The signal conditioning circuit 23 can be in connection with the microprocessor 21 for connecting with the sensor 80. The power control circuit 24 can be in connection with the microprocessor 21 for controlling the power consumption during various modes of operation of the device. The power control circuit 24 may respond to input from the microprocessor 21 without regard to operator input through the pressing contact module 90. The charge control circuit 25 and battery protection circuit 26 that interface with the wireless charging module 40 to manage the use of the battery 60. The charge control circuit 25 and/or battery protection circuit 26 may be used to control the charging of the battery 60 and the discharging of the battery 60. The charge control circuit 25 and battery protection circuit 26 can be adapted to operate independently from the microprocessor 21.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. A massage device comprising: a main body, and a flexible outer layer completely sealing the main body.

2. The massage device of claim 1, wherein the main body comprises a first end body portion, a second end body portion substantially opposite the first end body portion, and an operation portion connecting the first end body portion and the second end body portion, and the main body defines a receiving chamber extending along the second end body portion, the first end body portion, and the operation portion.

3. The massage device of claim 2, further comprising a control circuit, a wireless communication module, a wireless charging module, a battery, at least two vibratory elements, and a sensor, wherein the control circuit, the wireless communication module, the wireless charging module, the battery, the at least two vibratory elements, and the sensor received in the receiving chamber; the wireless communication module, the wireless charging module, the battery, the at least two vibratory elements, and the sensor electrically coupled to the control circuit respectively; the at least two vibratory elements fixed in the receiving chamber adjacent to the second end body portion and the first end body portion respectively.

4. The massage device of claim 3, wherein the sensor is configured to detect a moving rate of the main body.

5. The massage device of claim 3, wherein the wireless communication module is configured to receive a control signal, and transmit the control signal to the control circuit for controlling vibrations of the at least two vibratory elements.

6. The massage device of claim 3, wherein the massage device further comprises a pressing contact module inserted into the operation portion, and partially received in the receiving chamber, the pressing contact module electrically coupled to the control circuit for allowing an operator control the vibrations of the at least two vibratory elements via the pressing contact module.

7. The massage device of claim 6, wherein the pressing contact module comprises a pressing contact module base body made of elastic shape memory materials, and at least one distance sensor; the pressing contact module base body is fixed in the operation portion, and partially exposed of the operation portion of the main body, and the at least one distance sensor embedded in the pressing contact module base body for controlling a vibration intensity of the at least two vibratory elements.

8. The massage device of claim 6, wherein the pressing contact module further comprises a light source electrically coupled to the control circuit, and positioned in the pressing contact module base body for illuminating the pressing contact module base body of the pressing contact module.

9. The massage device of claim 8, wherein the light source is LED.

10. The massage device of claim 6, wherein the pressing contact module further comprises a pressure sensor configured to detect a pressure level of the pressing contact module base body thereof, and transmit a pressure signal from the pressure sensor to the control circuit; the control circuit is capability of transmitting the pressure signals to an intelligent terminal or internet via the wireless communication module.

11. The massage device of claim 7, wherein the pressing contact module base body is made of EVA foam or Polyurethane.

12. The massage device of claim 3, wherein the massage device further comprises a base having a first holding portion for receiving the second end body portion, and a second holding portion for receiving the first end body portion, thereby the main body standing on the base, and the operation portion of the main body is above the base.

13. The massage device of claim 12, wherein the wireless charging module comprises a transmitting terminal positioned in the base between the first holding portion and the second holding portion, and a receiving terminal positioned in the receiving chamber of the main body.

14. The massage device of claim 12, wherein the base further comprises an interface in connection with the transmitting terminal.

15. The massage device of claim 3, wherein the control circuit comprises a microprocessor receiving input from the sensor.

16. The massage device of claim 15, wherein the control circuit further comprises a motor driver circuit for converting signals from the microprocessor into signals sufficient to operate the vibratory element according to commands from the microprocessor.

17. The massage device of claim 15, wherein the control circuit further comprises a signal conditioning circuit in connection with the microprocessor for connecting with the sensor.

18. The massage device of claim 15, wherein the control circuit further comprises a power control circuit in connection with the microprocessor for controlling the power consumption during various modes of operation of the device.

19. The massage device of claim 15, wherein the control circuit further comprises a charge control circuit configured for controlling the charging of the battery and the discharging of the battery.

20. A massage apparatus comprising:
a massage device having a main body substantially enclosing a defined space, the main device body having a flexible outer layer;
a base configured to receive the massage device in a resting position;
two or more vibratory units positioned within the defined enclosed space of the mains device body;
at least one rechargeable power unit positioned within the defined enclosed space of the main device body, the at least one rechargeable power unit providing power to the two or more vibratory units;
a wireless charging module with a transmitting terminal attached to the base and a receiving terminal positioned within the defined enclosed space of the main device body;
a sensor positioned within the defined enclosed space of the main device body;
a wireless communication module positioned within the defined enclosed space of the main device body; and
a control circuit positioned within the defined enclosed space of the main device body, the control circuit coupled to the two or more vibratory units, the control circuit being coupled to the wireless communication module, the receiving terminal of the wireless charging module, the at least one rechargeable power unit, the sensor and the two or more vibratory units;
wherein, when in the resting position of the massage device, the receiving terminal of the wireless charging module is positioned to allow wireless charging of the rechargeable power unit from the transmitting terminal of the wireless charging module; and
wherein, the wireless communication module is configured to receive a control signal and transmit the control signal to the control circuit for controlling the vibratory elements.
